(19) United States
(12) Patent Application Publication
(10) Pub. No.: US 2013/0105283 A1
(43) Pub. Date: May 2, 2013

(54) DRUM MOTOR HAVING PROFILED CASING

(71) Applicants: Siegmund Dudek, Heinsberg (DE); Palani Velladurai, Monchengladbach (DE)

(72) Inventors: Siegmund Dudek, Heinsberg (DE); Palani Velladurai, Monchengladbach (DE)

(73) Assignee: Interroll Holding AG, Sant' Antonino (CH)

(21) Appl. No.: 13/456,855

(22) Filed: Apr. 26, 2012

(30) Foreign Application Priority Data
Nov. 23, 2009 (DE) 20 2009 015 912.4
Nov. 23, 2010 (EP) PCT/EP2010/067999

(51) Int. Cl. B65G 23/08; H02K 7/10

(52) U.S. Cl. CPC B65G 23/08; H02K 7/10
USPC 198/835; 310/80; 417/375; 415/182.1

(57) ABSTRACT

The invention relates to a drum motor comprising: a drive unit, such as a rotor/stator unit of an electric motor, or a hydraulic or pneumatic actuator unit, an output shaft connected to the drive unit for transmitting force and torque, an outer drum, which surrounds the output unit at least partially and is rotatably mounted relative to a fastening axis, and a casing, which is connected to the outer surface of the rotatable drum and has a profile. According to the invention, the profile contains a helical groove (40) in the casing that extends over at least part of the surface of the casing and runs helically about the rotational axis of the rotatable drum.

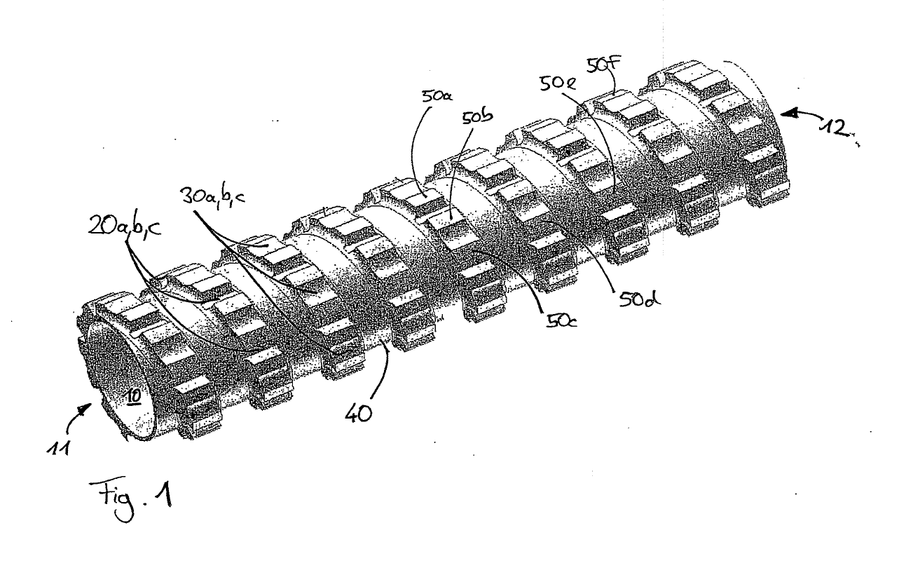

### CROSS REFERENCE TO RELATED APPLICATIONS

This application is a continuation of PCT/EP2010/067999 filed 23 Nov. 2010, the content of which is incorporated by reference herein in its entirety for all purposes, and which in turn claims priority under International Law to German Patent Application 20 2009 015 912.4 filed 23 Nov. 2009.

### BACKGROUND OF THE INVENTION

The invention relates to a drum motor comprising:
a drive unit, such as a rotor/stator unit of an electric motor, or a hydraulic or pneumatic actuator unit,
an output shaft connected to the drive unit for transmitting force and torque,
an outer drum which surrounds the output unit at least partially and is rotatably mounted relative to a fastening axle,
a casing which is connected to the outer surface of the rotatable drum and has a profile.

Drum motors having the aforementioned construction are used in the field of goods transport, especially, and serve as a primary drive source for conveyor belts. For this purpose, a drum motor has a cylindrical outer drum surface which can be made to rotate, by a drive motor mounted inside the drum, relative to a fastening axle disposed on said drive motor. The fastening axle typically runs coaxially with the rotational axis of the drum and may be formed, for example, by two axle units disposed on the drum motor at the respective end faces and extending axially from the end faces.

Drum motors are used in different installation environments, including logistics applications, industrial applications, and applications in environments requiring high standards of hygiene and IP (ingress protection) rates, such as applications in the food, chemicals or pharmaceuticals industry.

In applications with such stricter hygiene requirements, it must be possible to clean drum motors in a simple and at the same time reliable manner.

Meeting these hygiene requirements by means of a rubber layer applied to the drum motor surface and which consists of a suitably resilient, easily cleaned rubber material is known. Providing positive engagement, in the manner of a toothed belt with a toothed belt wheel, in order to transmit the torque from the drum motor surface to the conveyor belt, in that axially extending axial grooves are introduced into the drum motor surface and cooperate with matching cross ribs on the conveyor belt, is also known. As an alternative in this regard, transmitting a torque by means of toothed wheels which are welded onto the drum motor surface and which cooperate with matching counter-profiles on the conveyor belt is also known.

Drum motors deployed in hygienically sensitive areas must conform to increasingly tough requirements with regard to safety against contamination, nesting of germs, and the like. At the same time, greater pressure to minimize costs in fields of production or use which use such drum motors engenders the wish to reduce the effort and expense that is needed for cleaning. In addition, there is ultimately pressure to minimise the cost of purchasing drum motors, which is reflected for makers of drum motors in pressure to reduce the production costs for drum motors without compromising on functions or quality.

On account of these different requirements, there is a need for a drum motor which can be operated in a more reliable manner in fields of application in which high standards of hygiene are required, while being simple and inexpensive to produce.

### SUMMARY DESCRIPTION OF THE INVENTION

This need is met, according to the invention, by a drum motor of the kind initially specified, in which the profile contains a helical groove in the casing, said helical groove extending over at least part of the surface of the casing and running helically about the rotational axis of the rotatable drum.

Due to the specific design of the profile of the drum motor according to the invention, the surface of the drum motor can be cleaned in a simple manner by a jet of liquid when a conveyor belt is placed on it. By means of the helical groove in the profile, the liquid is distributed in such a way that the entire surface of the drum of the drum motor can be wetted with the cleaning fluid, while also allowing the conveyor belt surface engaging with the drum motor to be wetted also. The disadvantage of the prior art is thus prevented, namely that parts of the latter surface cannot be reached by the fluid because they are closed off by the seal that is effected between the conveyor belt and the drum motor surface. What is also achieved at the same time is that the cleaning fluid can drain reliably from all regions of the drum surface and the conveyor belt, thus preventing the formation of liquid reservoirs in which germs can accumulate.

It should be understood that the effect achieved by the invention can basically be achieved when the helical groove extends over part of the drum casing surface. It is preferred, in particular, that the helical groove extend across the entire axial length of the drum of the drum motor. This ensures that the cleaning effect is also applied over the entire axial length of the drum and across the entire width of the conveyor belt.

Owing to the inventive geometry of the profile, a cleaning fluid can reach the entire width of a conveyor belt rolling over the drum and can run off the conveyor belt across its entire width.

According to a first preferred embodiment, the profile comprises a plurality of parallel, circumferentially spaced-apart axial grooves which thus define a plurality of profile sections which are separate from each other and protrude from the bottom surface of the helical groove and the axial grooves. With this development of the invention, a drum surface is provided that has a profile suitable for transmitting torque by means of positive engagement with a conveyor belt having a profile with longitudinal ribs, without unwanted axial forces being transferred thereby to the conveyor belt, which might lead to the conveyor belt jumping off, and without abandoning the advantageous cleaning capability that the inventive profile provides.

It is particularly preferred in this regard when the depth of the helical groove differs from, and in particular is greater than the depth of the axial grooves. This configuration achieves reliable distribution of a cleaning fluid along the helical groove, also in such regions that are covered by a conveyor belt that has matching toothed ribs which engage with the respective axial grooves.

It is still further preferred that the axial grooves extend parallel to the rotational axis so that the torque is transmitted by a positive engagement mechanism that is free of axial thrust yet inexpensive to produce.

The embodiments having axial grooves may be further developed such that the axial grooves include a first type of axial groove having a first width, and a second type of axial groove having a width different from the first width. This construction with two different types of axial groove can be used to cooperate with a conveyor belt having matching longitudinal ribs that, on account of their geometry and distance apart, cooperate with only one of the two types of axial groove, as a consequence of which the axial grooves of the other type can also serve as conduits for a cleaning fluid in a region of the drum that the conveyor belt loops around, and can thus improve the axial distribution of the cleaning fluid from one winding of the helical groove to an adjacent winding of the helical groove. It should be understood in this regard that this advantage is specifically achieved when the first type of axial groove and the second type of axial groove are distributed alternatingly over the surface of the drum, such that one axial groove in positive engagement with a rib of the toothed belt is arranged adjacent to an axial groove without such positive engagement, as a result of which it is possible for liquid to flow through the latter. It should be understood, however, that other arrangements are also included in the invention, for example arrangements in which two fluid-conducting axial grooves of the one type are followed by one positively engaging, torque-transmitting axial groove of the other type.

It is still further preferred that the axial grooves of the first type have a depth which differs from the depth of the axial grooves of the second type. This construction, in which the two types of axial grooves have differing depths, allows better distribution of the cleaning fluid, even when a rib of the toothed belt engages with each axial groove, in that the cleaning fluid is able to flow continuously through the deeper grooves at least. This development also allows those axial grooves in which no rib portion of the conveyor belt comes to rest to be designed less deep than the other axial grooves, in order to reduce the jaggedness of the drum motor surface.

It is still further preferred when a plurality of helical grooves are provided over at least one part of the said casing and run helically about the rotational axis of the drum. In this development of the invention, a plurality of such windings in the manner of a multi-start thread, in particular a two-, three- or four-start thread, is provided instead of a single, thread-like helical groove that runs in one or more windings about the drum surface, as a result of which plurality of windings the distribution of the cleaning fluid is improved still more. It should be understood in this regard that the individual threads of the multi-start thread may be designed with identical geometry or with differing geometry, for example with different widths or depths of the helical grooves. More particularly, the plurality of helical grooves may be designed in such a way that helical grooves with different pitches are used, as a result of which the grooves are wetted advantageously among one another, thus achieving even better distribution of the cleaning fluid over the drum surface.

As a basic principle, the effect according to the invention can be achieved with a winding that extends 360° over the entire length of the drum. However, a particularly preferred embodiment is one in which the helical groove extends in a plurality of windings over the drum surface, and in particular it is preferred when the number of windings does not exceed triple the amount of the length-diameter ratio of the drum. There should be at least three windings over the total length of the drum.

It is still further preferred that the width of each helical groove in the axial direction be approximately equal to the pitch of the helical grooves. This results in a profile geometry with good and reliable positive engagement for torque transmission as well as efficient distribution of liquid for the cleaning process.

According to another preferred embodiment, the casing is made of plastic, in particular of a rubbery elastic plastic. The casing can be advantageously applied by a vulcanization process to the surface of the rotatable drum, or glued to said surface.

Another aspect of the invention is a drum motor arrangement, comprising the drum motor according to any one of the previously described constructions and a conveyor belt which loops at least partially around the outer drum motor surface and has ribs on its surface facing the drum motor surface which match at least some of the axial grooves. Such a drum motor arrangement permits particularly efficient transmission of torque between the drum motor and the conveyor belt, while also allowing the cleaning of both the drum motor surface and the conveyor belt to be carried out in a reliable and simple manner. The conveyor belt may be so designed that it has ribs which are spaced apart in such a way that they engage only with every second, third or fourth axial groove in the drum motor surface.

Another aspect of the invention, finally, is a casing of a drum motor, said casing being characterized by having a profile on its outer surface, said profile containing a helical groove which runs helically about the rotational axis of the rotatable drum of a drum motor. Such a casing can be used to develop existing drum motors in the inventive manner by retrofitting them in such a way that the aforementioned casing is applied to the drum motor surface, for example by vulcanization or gluing, or also, where relevant, by shrinking, clamping, or the like.

The casing may be developed in this regard by embodying it in the manner of the casing previously described for the drum motor.

### BRIEF DESCRIPTION OF THE DRAWING

A preferred embodiment shall now be described with reference to the attached FIGURE, which shows a perspective view of a drum motor casing.

### DETAILED DESCRIPTION

As can be seen, the casing has a cylindrical basic shape and encloses an inner, cylindrical hollow space 10 in which the drum motor is disposed. It should be understood in this regard that an axle mount may extend from each of the two open end faces 11, 12 of the cylindrical basic shape of the casing, in order to mount the drum motor in a rack frame or the like.

The outer cylindrical surface of the casing has a plurality of axial grooves 20a, b, c . . . and 30a, b, c. The axial grooves are subdivided into a first type 20a, b, c and a second type 30a, b, c and are arranged alternatingly with each other in the circumferential direction. The first type of axial groove 20a, b, c is used to cooperate in positive engagement with a matching cross rib on a conveyor belt, in order to transmit a torque from the drum motor to the conveyor belt. The second type of axial groove 30a, b, c does not engage with a matching rib of a conveyor belt, but is merely covered radially by the conveyor belt, as a result of which the axial groove forms a longitudinal conduit in the region of the casing about which the conveyor belt is looped.

The casing also has a helical groove 40 which winds itself, in the form of a single-start thread, in a plurality von windings about the surface of the casing.

Helical groove 40 is cut into the casing in such a way that it interrupts the axial grooves 20a, b, c and 30a, b, c, thus forming a plurality of single profile blocks 50a, b, c, d, e, f . . . which form the outer, supporting surface of the drum motor.

The depth of helical groove 40 matches the depth of the axial grooves of the first type. The depth of the axial grooves of the second type 30a, b, c, in contrast, is less than the depth of the axial grooves of the first type 20a, b, c and of helical groove 40.

The width of helical groove 40 is approximately equal to the pitch of the single-start thread. The width of the axial grooves of the second type 30a, b, c is approximately equal to the width of the helical groove, whereas the width of the axial grooves of the first type 20a, b, c is less than the width of the axial grooves of the second type 30a, b, c and of the helical groove. The axial groove of the second type 30 a, b, c specifically provides the necessary free space for chain links or conveyor belt joints, or the like, and also makes it easier to clean the drum surface by providing better distribution of the cleaning fluid.

What is claimed is:

1. A drum motor, comprising:
a drive unit, such as a rotor/stator unit of an electric motor, or a hydraulic or pneumatic actuator unit,
an output shaft connected to the drive unit for transmitting force and torque,
an outer drum which surrounds the output unit at least partially and is rotatably mounted relative to a fastening axle,
a casing which is connected to the outer surface of the rotatable drum and has a profile,
characterized in that:
the profile contains a helical groove in the casing, said helical groove extending over at least part of the surface of the casing and running helically about the rotational axis of the rotatable drum.

2. The drum motor according to claim 1, characterized in that the profile comprises a plurality of parallel, circumferentially spaced-apart axial grooves which thus define a plurality of profile sections which are separate from each other and protrude from the bottom surface of the helical groove and the axial grooves.

3. The drum motor according to claim 2, characterized in that the depth of the helical groove differs from, and in particular is greater than, the depth of the axial grooves.

4. The drum motor according to claim 2, characterized in that the axial grooves extend parallel to the rotational axis.

5. The drum motor according to claim 2, characterized in that the axial grooves include a first type of axial groove having a first width, and a second type of axial groove having a width different from the first width.

6. the drum motor according to claim 5, characterized in that the axial grooves of the first type have a depth that differs from the depth of the axial grooves of the second type.

7. The drum motor according to claim 1, characterized in that a plurality of helical grooves are disposed over at least one part of the said casing and run helically about the rotational axis of the drum

8. The drum motor according to claim 7, characterized in that each helical groove has at one winding that extends 360° over the length of the drum.

9. The drum motor according to claim 7, characterized in that the width of each helical groove in the axial direction is approximately equal to the pitch of the helical grooves.

10. The drum motor according to claim 1, characterized in that the casing is made of plastic, in particular of a rubbery elastic plastic.

11. The drum motor according to claim 1, characterized in that the casing is applied by a vulcanization process to the surface of the rotatable drum, or is glued to the outer surface of the rotatable drum.

12. A drum motor arrangement, comprising the drum motor according to claim 2 and a conveyor belt which loops at least partially around the outer drum motor surface and has ribs on its surface facing the drum motor surface which match the axial grooves.

13. A casing of a drum motor, characterized in that the casing has a profile on its outer surface, said profile containing a helical groove that runs helically about the rotational axis of the rotatable drum of a drum motor.

14. The casing according to claim 13, characterized in that the casing profile has a plurality of parallel, circumferentially spaced-apart axial grooves which thus define a plurality of profile sections which are separate from each other and protrude from the bottom surface of the helical groove and the axial grooves.
